(19) United States
(12) Patent Application Publication
(10) Pub. No.: US 2013/0073351 A1
(43) Pub. Date: Mar. 21, 2013

(54) Point-Based Rewards

(71) Applicants: Jacob Bair, Ammon, ID (US); Chelsey Eddins, Idaho Falls, ID (US); Ben Sweetwood, Ammon, ID (US); Natalie Messano, Idaho Falls, ID (US); Justin Summers, Ammon, ID (US); Brandon Mucci, Idaho Falls, ID (US)

(72) Inventors: Jacob Bair, Ammon, ID (US); Chelsey Eddins, Idaho Falls, ID (US); Ben Sweetwood, Ammon, ID (US); Natalie Messano, Idaho Falls, ID (US); Justin Summers, Ammon, ID (US); Brandon Mucci, Idaho Falls, ID (US)

(73) Assignee: MELALEUCA, INC, Idaho Falls, ID (US)

(21) Appl. No.: 13/616,739

(22) Filed: Sep. 14, 2012

Related U.S. Application Data
(60) Provisional application No. 61/535,256, filed on Sep. 15, 2011.

(51) Int. Cl. G06Q 30/02

(52) U.S. Cl. 705/14.1

(57) ABSTRACT

A computer-implemented method for a points-based rewards program includes identifying, with a computer system, events that are associated with users of a business application; awarding, in response to the occurrence of an event identified by the computer system, points to the user associated with the event, where the points awarded are based on a business importance of the event, the business importance being determined by the computer system; storing the awarded points in a points account for the user; providing options to the user for redeeming the points in return for objects; redeeming, in response to a selected redemption option, one or more selected objects from the objects, and reducing points in the points account by an amount corresponding to the one or more selected objects; and causing the selected one or more objects to be provided to the user.

### CLAIM OF PRIORITY

This application claims priority under 35 USC §119(e) to U.S. Provisional Application Ser. No. 61/535,256, filed on Sep. 15, 2011, the entire contents of which are hereby incorporated by reference.

### BACKGROUND

1. Technical Field

This document relates to methods for managing rewards systems, such as points-based rewards systems.

2. Background Information

Many companies that produce products and/or services can sell and support the products/services via sales or support teams, which may communicate with customers via telephone connections from call centers. Employees who work in sales or support, including in a call center, can perform many tasks, including answering telephones, dealing with customers, and reporting results. Some of the employees in these positions may have little incentive to perform well. Close monitoring of such employees may also have negative effects, such as by causing resentment and perhaps decreased employee performance.

### SUMMARY

This document discusses computer-based systems and techniques for tracking performance of workers in an organization and awarding points to the workers that are based on a determined business value of work or other actions performed by the workers. The points may then be placed in accounts for particular corresponding workers, and may be redeemed so that objects—such as physical items, electronic media, certificates for obtaining services (whether the certificates are in physical or electronic form)—can be obtained by workers in exchange for the points.

In some implementations, a computer-implemented method for executing a points-based rewards program is disclosed. The method comprises identifying, with a computer system, events that are associated with users of a business application; awarding, in response to the occurrence of an event identified by the computer system, points to the user associated with the event, where the points awarded are based on a business importance of the event, the business importance being determined by the computer system; storing the awarded points in a points account for the user; providing options to the user for redeeming the points in return for objects; redeeming, in response to a selected redemption option, one or more selected objects from the objects, and reducing points in the points account by an amount corresponding to the one or more selected objects; and causing the selected one or more objects to be provided to the user. The method can also include providing a negotiation tool for enabling the user to negotiate a number of points to be used in redemption for an object. The negotiation tool can enable offers, by the user, for obtaining the object for a reduced number of points; and enable counter-offers, by an administrator of the rewards program, in response to offers from the user.

In some examples, the method also comprises providing an auction for one or more users to bid on selected objects using points from their points accounts. The method can further comprise using metrics to adjust the points awarded in response to the occurrence of the event. Adjusting the points can comprise rewarding the user with additional points that are awarded based on metrics, or retracting points from the user based on an occurrence of an event that has a negative business impact. Also, the event can be an event selected from a group consisting of sales calls, conversions, orders placed, enrollments completed, customer service calls, service support calls, business development calls, and outbound calls.

In other implementations, one or more tangible machine-readable media are disclosed that have recorded thereon instructions that, when executed, cause the performance of various operations that include the operations discussed above.

Unless otherwise defined, all technical and scientific terms used in this document have the same meaning as commonly understood by one of ordinary skill in the art to which this disclosure pertains. In addition, the materials, methods, and examples provide here are illustrative and not intended to be limiting.

Other features and advantages will be apparent from the following detailed description, and from the claims.

### DESCRIPTION OF DRAWINGS

FIG. 1 is a screen shot of an example rewards/points display.

FIG. 2 is a screen shot of an example email that the associate can receive.

FIG. 3 is a screen shot of an example winners screen.

FIG. 4 is a screen shot of an example points summary.

FIGS. 5A and 5B are screen shots of example auction displays.

FIG. 6 is a screen shot of an example request screen.

FIG. 7 is a screen shot of an example request new item screen.

FIG. 8 is a screen shot of an example counter-offer screen.

FIG. 9 is a screen shot of an example offer-counter offer screen.

FIGS. 10A-10C show example displays of request rewards that associates can request.

FIG. 11 is a screen shot of an example form on which the associate can register for discounted prizes.

FIG. 12 is a screen shot of a sold-out display.

FIGS. 13A-13C show example discounted prizes.

FIG. 14 is a block diagram of an example flow of events in the rewards program.

FIG. 15 is a flow diagram of an example process for the rewards program.

FIG. 16 is a block diagram of an example computer system that can be used to implement the systems and techniques described in this disclosure.

Like reference numbers and designations in the various drawings indicate like elements.

### DETAILED DESCRIPTION

This document describes a point-based rewards system, such as can be used with call-center employees (who may be referred to as associates). Successful activities by particular associates can yield points that can be used by the associates to obtain items. The rewards system can work as an incentive program that encourages associates to take more calls by awarding points that can be redeemed for various prizes. The system can track an associate's calls and other events and assign points accordingly. Once the associate has accumulated enough points, the points can be redeemed for rewards.

The system can provide incentives that can be exciting and personal for each associate. For example, an associate may complete a profile that identifies his or her hobbies, interests, and the like, and objects directed to those interests can be presented to the associate to incentivize the associate. As a result, associates may be willing to take more calls and volunteer for extra shifts to earn extra points. Also, associates may have greater morale and work longer with a company. Some associates may be willing to call out during idle time to earn additional points, which can increase productivity and service level, and lead to increased sales.

In some implementations, the points earned can be used to rank associates and determine areas in which an associate is more qualified as compared to other associates. For example, an associate who earns more points for selling specials (products or services that are offered at a special price and/or are currently being promoted or upsold) may be routed more sales calls. Such an associate may also be routed calls that are determined to be more susceptible to upsells and the like, such as calls from certain area codes. Typically, an associate who earns more points id performing business-driving activities. In some implementations, top associates can be invited to recognition luncheons to celebrate their accomplishments. Also, certain associates may be surprised with a free meal in a corporate cafeteria when they attempt to pay for a meal.

The system can include the use of business rules. For example, rules related to metrics are one category of business rules that may be employed. In some implementations, at least seven different metrics can exist in which the associates can earn points, e.g., orders taken, enrollments completed, customer service calls, service support calls, business development calls, and outbound calls.

Another category of business rules includes locations, administration, purchasing, and distribution. For example, there can be an administrator and an assistant administrator for both each of the different call centers. The Administrator, for example, can purchase and distribute all prizes, e.g., with the help of the assistant administrator. Once an associate redeems their points for a prize, the prize can be delivered to the associate within an hour, and the associate can be congratulated by the managers within that time frame. A signature can be obtained from the associate, acknowledging that they received the reward.

Another category of business rules includes marketing promotions. Marketing promotions can be in the form of points which can be redeemed for prizes.

Yet another category of business rules includes agreements that are associated with the rewards program. For example, each associate that participates in the rewards program can be asked to sign an agreement that indicates they have read and accepted the rules and policies of the rewards program.

Another category of business rules includes participants. For example, any employee who agrees to the terms of the rewards program and takes calls in the call center can earn points. In some implementations, participants in the rewards program can include all or some of full-time, part-time, and various other types of employees and colleagues.

Suspension is another category of business rules. For example, associates who do not perform at a minimum standard can be suspended from the rewards program for a set time period, depending on the type of suspension. During this time, the associate can be blocked from earning additional points or redeeming their existing points for rewards.

Reporting is another category of business rules. A manual adjustment report, for example, can show all manual adjustments to points rewarded to associates, and the report can be reviewed regularly by the director of the call center. A payroll report, for example, can show all income additions for associates based on rewards received.

Another category of business rules includes inventory and reconciliation. For example, inventory can be tracked and reconciled on a monthly basis, e.g., by an accounting department. In some implementations, reconciliation can include monthly reconciliation of credit card accounts that are used for rewards program purchases.

In some implementations, points can be awarded to associates based on metrics. Example metrics used with the rewards program can include: orders placed, enrollments completed, customer service calls, services support calls, business development calls, outbound calls, point retractions, and supervisor points.

For example, using metrics for placed orders, each call taken by an associate can result in the associate receiving one point. Orders numbering at least 50 in a day can result in two points being awarded per order.

Using metrics for completed enrollments, for example, an associate can be awarded a point for each completed enrollment. Completed enrollments totaling 25 or more per day can result in two points being awarded per completed enrollment.

Using metrics for customer service calls, for example, for each customer service call that an associate handles and for which the customer does not call back for additional customer service support within 72 hours (nor cancels within 30 days), the associate can be awarded three points. In another example, if an order is taken during a call, the associate can receive an additional 3 points.

Using metrics for services service calls, for example, each service support call that an associate handles and in which the customer does not call back for additional service support within 72 hours can result in three points being awarded to the associate. In another example, if an order is taken during the call, the associate can receive an additional three points.

Using metrics for business development calls, for example, any business development call can result in two points per call. In another example, if a marketing executive achieves a new executive status, any associate that helped that marketing executive during that compensation period can receive two points for each call. For example, these points can be awarded in the month following advancement.

Using metrics for outbound calls, for example, for each outbound call that is logged, the associate can receive one point.

Using metrics for point retractions, for example, points can be retracted when callbacks occur for the same type of call that was originally placed. For example, if a customer calls into a customer service department regarding an order, and then calls back within 72 hours with a question about their account, then no points will be retracted. In another example, if a customer calls customer service about returning their order, but then later decides not to, but then calls back within 72 hours and returns the product, the points for the original call can be retracted. In another example, all points earned from a customer, for all call types, that cancels within 30 days can be be retracted from any and all associates that earned points by helping that customer that month. In some implementations involving retractions for customers calling back within 72 hours (or similar predefined time period), the retraction can be applied only to the associate that last spoke with the customer.

Using metrics for supervisor points, for example, supervisors can receive points by taking calls. In another example, supervisors can receive a weekly minimum of their team's points through automatic adjustments added each Sunday. In another example, supervisor points can be removed if required “side-by-side” meetings are not completed each month. Reporting managers can notify a support team to retract points.

In some implementations, other metrics can be used for rewarding and/or retracting points. In some implementations, other points systems can be used, or other objects can be used in lieu of points, such as cash, products, other forms of reward, or any combination thereof.

Some implementations can enforce minimum expectations that apply to associates in the rewards program. For example, if an associate fails to meet any of the requirements associated with minimum expectations, they will not be eligible to earn points. Example requirements include: a) the associate must maintain minimum call center productivity standards, b) the associate must maintain a quality development score of 80% or above, c) the associate must be in good standing with company that administers the rewards program, and d) the associate cannot be on a written warning to participate. Other requirements and minimum expectations can be used.

Various displays and prize redemption options can be used by associates who want to view or redeem their points. For example, the options can include rewards/points displays (e.g., “Reward Vault”), auctions (e.g., “Kudos Auction”), prize requests/redemptions (e.g., “Kudos Request), and discounts (e.g., “Kudos Woot Woot”).

For example, rewards/points displays (e.g., “Reward Vault”) can be available for associates to view on their screen at all times while they are talking to a customer. In some implementations, the displays can list all types of rewards that the associates can receive, the number of points required, and the number of items of that type available. Their points can be updated in real-time, for example, which can drive the associates to continually earn points.

Auctions (e.g., “Kudos Auction”) can be a feature that is available for associates to view on a different screen between calls. The auctions feature, for example, can allow the associates to outbid their fellow associates, which can create a competitive environment. In some implementations, products that are offered in auctions may not be available (e.g., for purchase by the associate) anywhere else.

Prize requests/redemptions (e.g., “Kudos Request) can be available for associates to view on a different screen between calls. For example, this feature can allow associates to bid for prizes of their choice. As a result, associates can be enticed to earn points for things they want but could never get on their own.

Discounts (e.g., “Kudos Woot Woot”) can be available for associates to view on a different screen between calls. This feature can allow the associates to sign up for discounts on products that may not be available anywhere else.

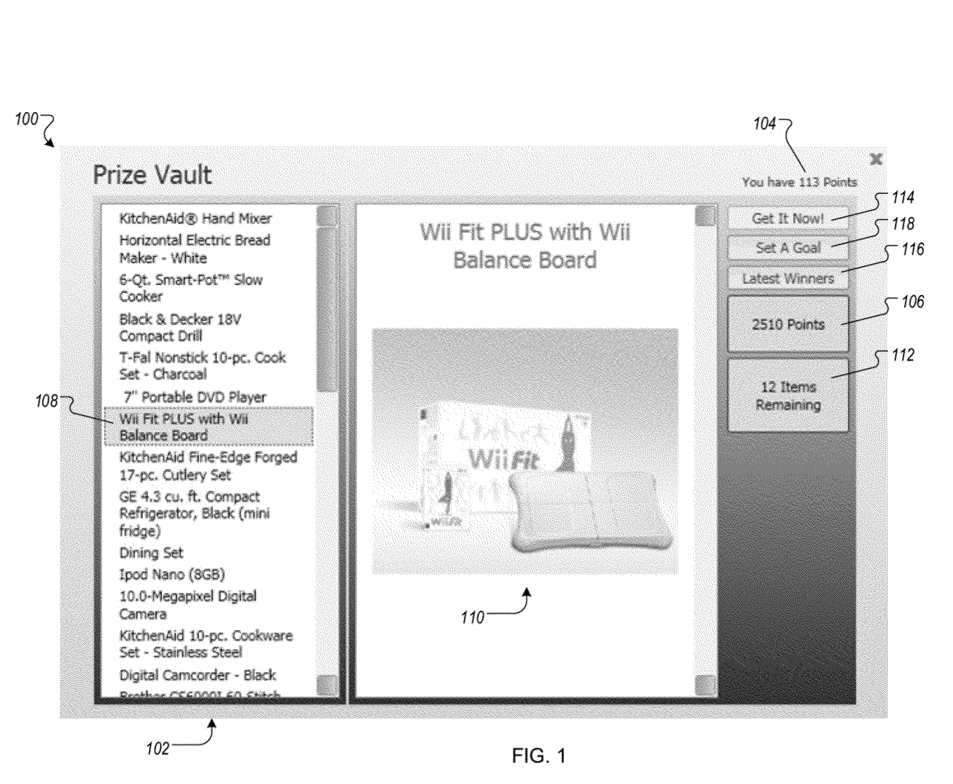

FIG. 1 is a screen shot of an example rewards/points display 100 (e.g., “Reward Vault”). In some implementations, the rewards system can be a third-party application, e.g., available over the Internet. In some implementations, the rewards/points display 100 can list the rewards 102 available to the associate, a current point total 104 for the associate, the number of points 106 needed to redeem a specific reward (e.g., the reward 108 currently selected), a photo 110 of the selected reward 108, the number 112 of that reward item available, and so on. For example, to redeem a reward, the associate can select a “Get It Now” option 114, which can result in sending an automatic email to the associate. In some implementations, the reward can be delivered to the associate by an administrator, and the associate's picture can be taken at that time.

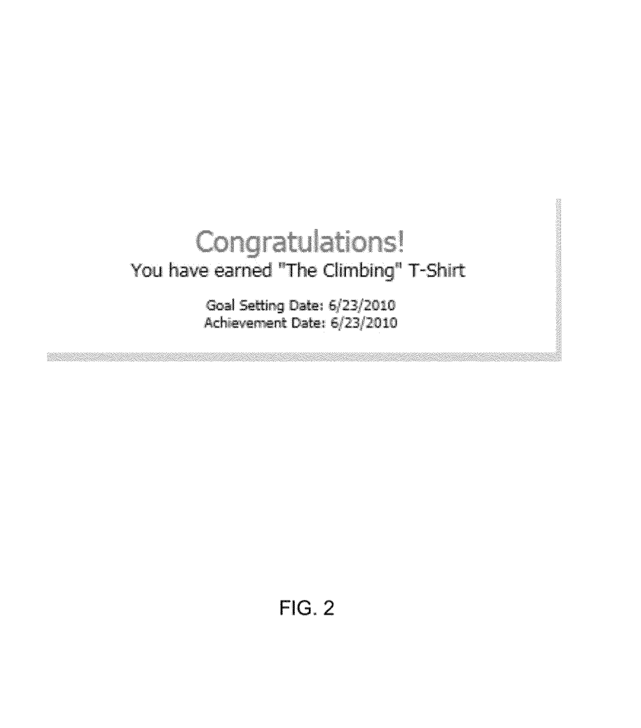

FIG. 2 is a screen shot of an example email 200 that the associate can receive after selecting the “Get It Now” option 114 on the rewards/points display 100. For example, the email that is sent lets the associate know that the reward indicated in the email has been obtained using points. The points can be removed automatically from the associate's account, and the associate can view their redemption on the bottom of their screen.

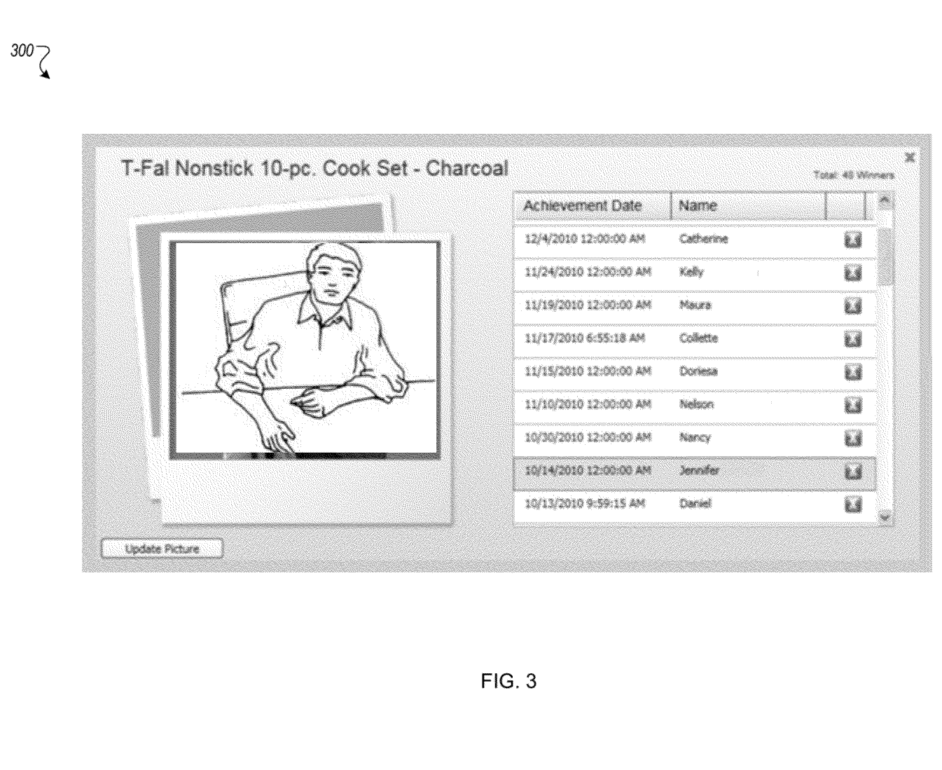

FIG. 3 is a screen shot of an example winner's screen 300 that the associate can view by selecting a “Latest Winners” option 116 on the rewards/points display 100.

In some implementations, associates can set goals for rewards they want to reach by clicking a “Set a Goal” button 118. Associates can view current goals and see how close they are to achieving each goal on their individual statistics page. Each individual's statistics page can tell them how many points they have earned in each category, their total points, their goals, and a status bar below the goal showing them how close they are to redeeming their reward.

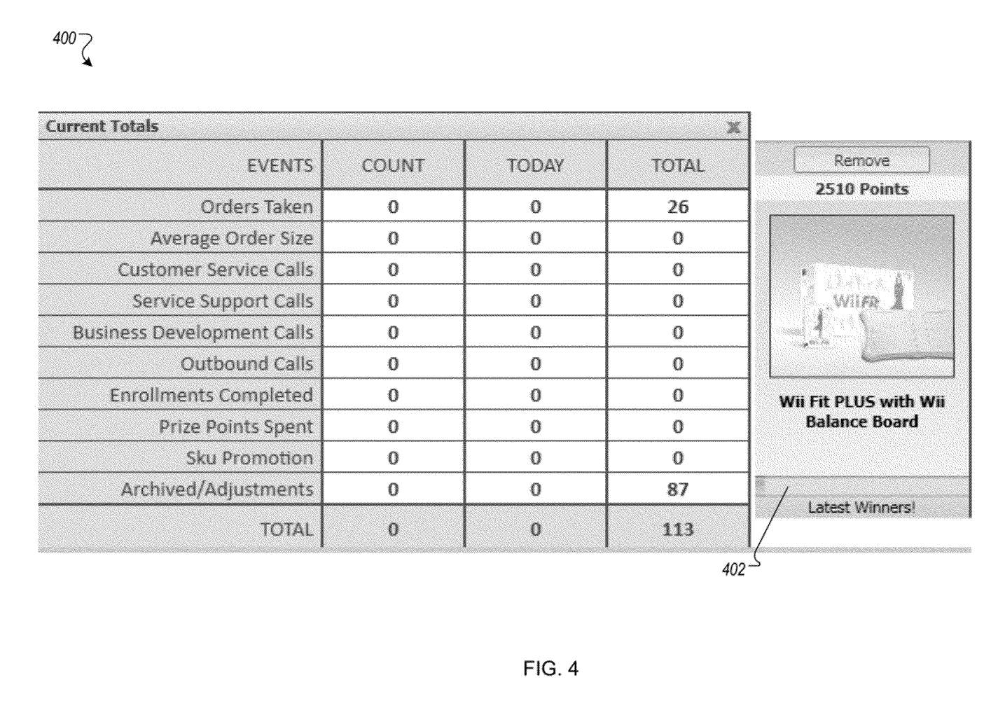

FIG. 4 is a screen shot of an example points summary 400. Using the points summary 400, the associates can view a bar 402 showing their progression toward a goal reward they selected in the rewards/points display 100.

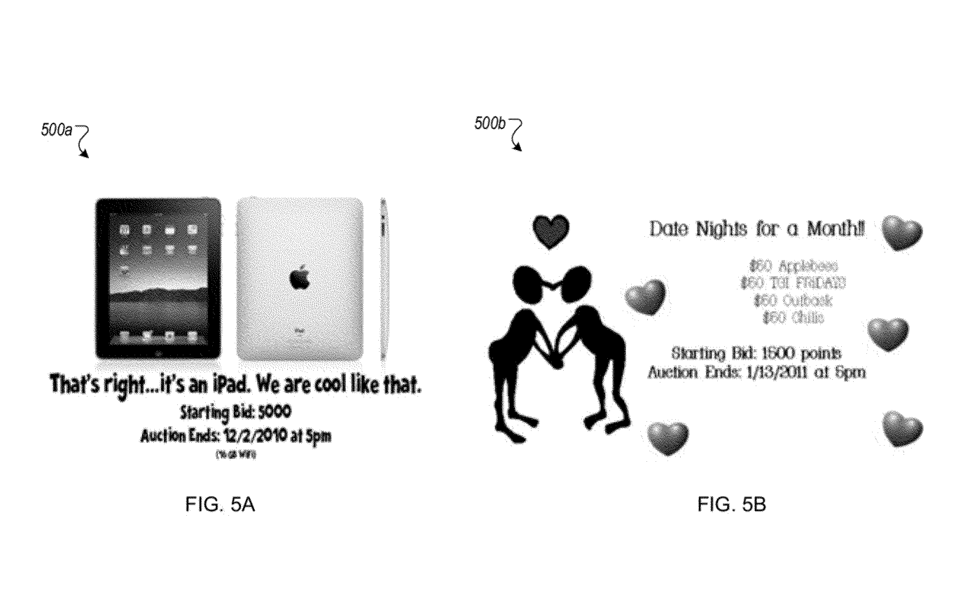

FIGS. 5A and 5B are screen shots of example auction displays 500a and 500b. For example, associates can view the auction displays 500a and 500b for auctions that are associated with rewards. In some implementations, auctions can be held quarterly, e.g., for each department participating in the rewards program.

Auctions can be operated in which associates bid on rewards, e.g., up to the limits of the number of points that each associate has accumulated. The reward can be awarded to the highest bidder. In some implementations, the auction winner's picture can be taken. In some implementations, silent auctions can be held online (e.g., using an intranet, SharePoint, etc.), and associates can be allowed to “bid” on the rewards. The associate with the highest bid at the designated end time can be the winner of the reward.

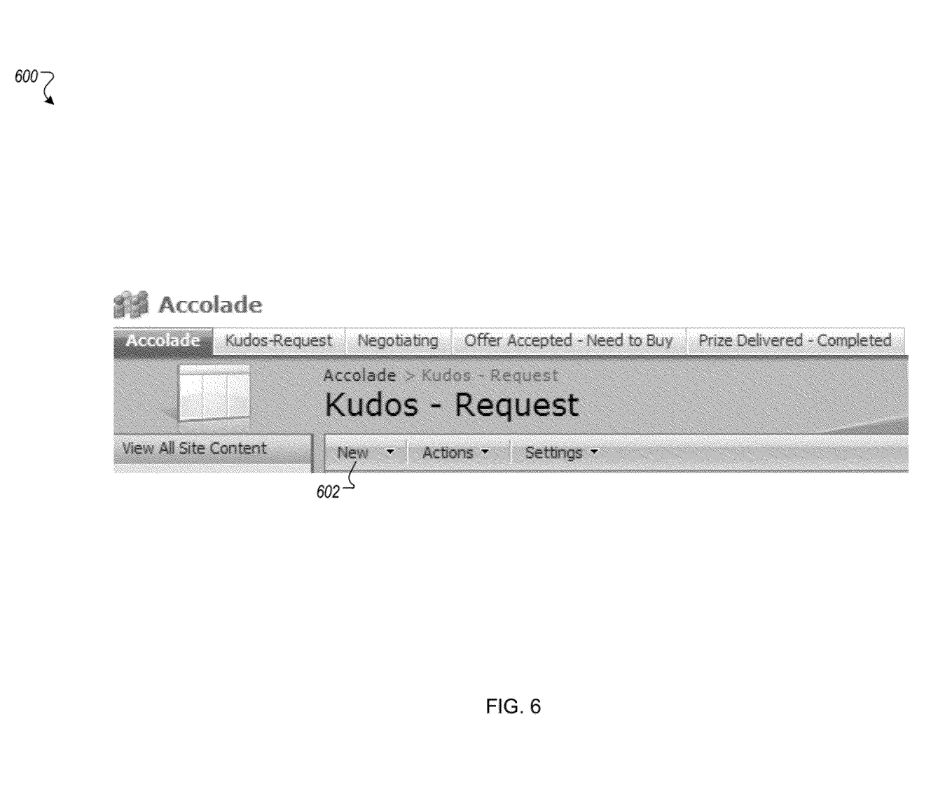

FIG. 6 is a screen shot of an example request screen 600. For example, the associate can use the request screen 600 to request rewards, e.g., through a “Kudos Request” Sharepoint site. To request a prize, for example, the associate can select (e.g., click on) a “New” control 602

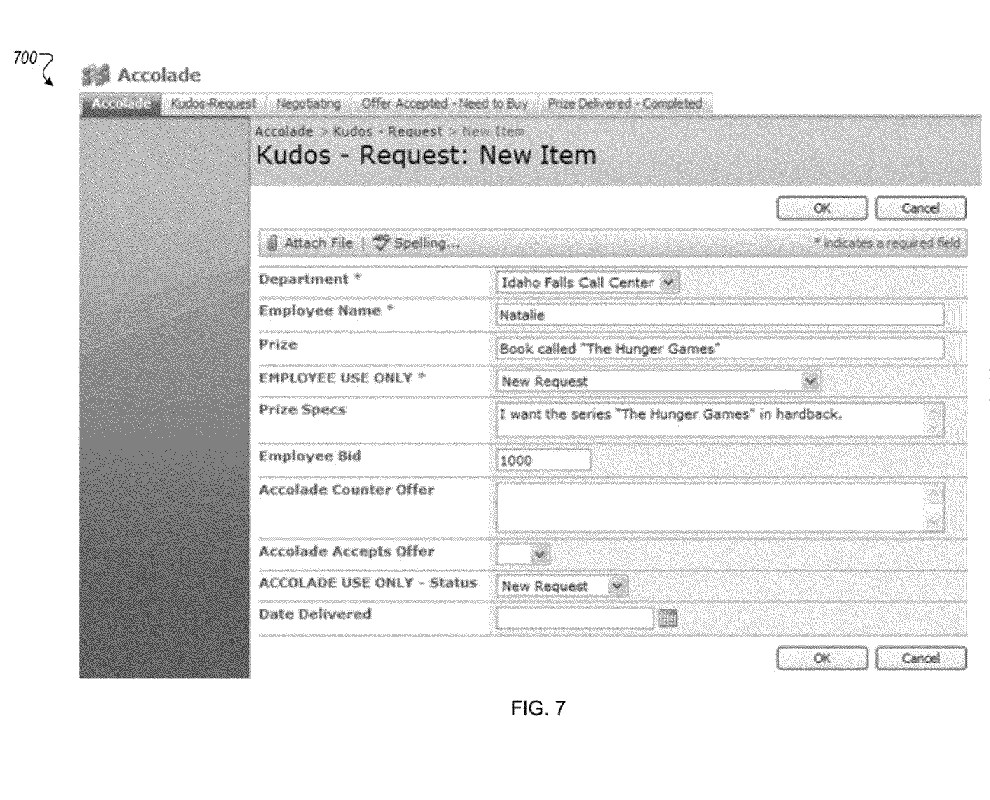

FIG. 7 is a screen shot of an example request new item screen 700. In some implementations, the associate can fill out the request new item screen 700 with the specifics of a reward they are requesting and the amount of points they would like to use. Once the associate has entered the information, the associate can select the “OK” button 702 to submit the request. Requests can be reviewed (e.g., automatically or by a program administrator), and the rewards program can send the associate a counter-offer based on the number of points required.

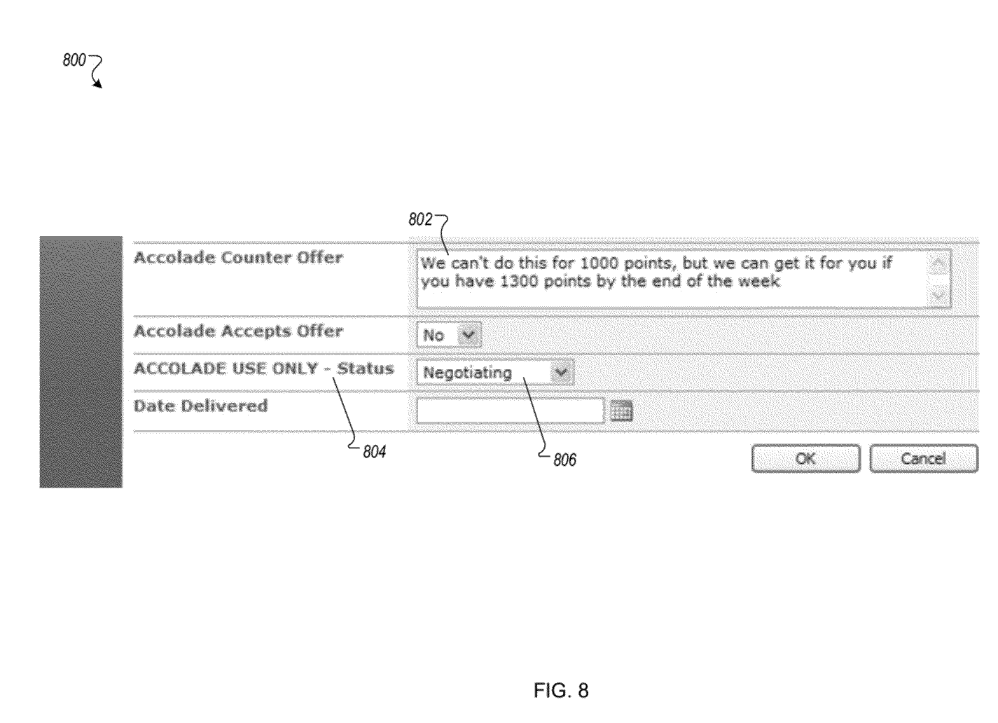

FIG. 8 is a screen shot of an example counter-offer screen 800. For example, the rewards program administrator can fill out a counter-offer field 802 and can change a status field 804 to a “Negotiating” value 806. The information that the rewards program administrator provides in the counter-offer screen 800 can appear in one or more screens that the associate can display.

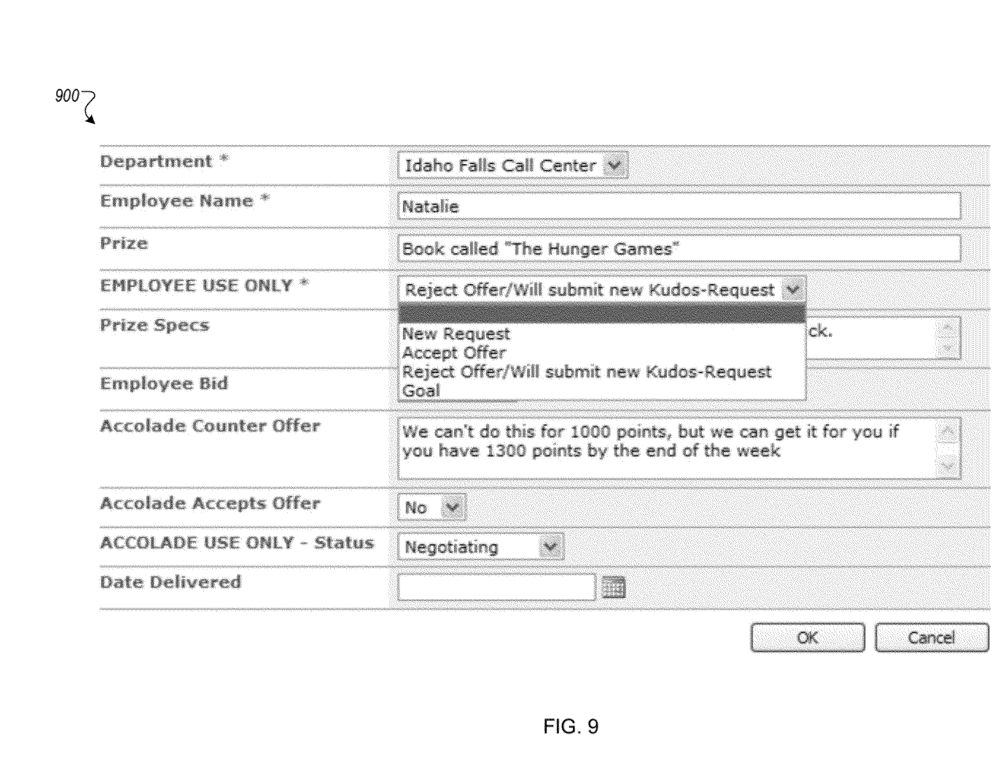

FIG. 9 is a screen shot of an example offer-counter offer screen 900. As shown in FIG. 9, the associate can continue to negotiate regarding the current offer, reject the offer, or accept the current offer. If the associate accepts the offer, for example, the reward prize can be purchased and distributed to the associate, and the associate's picture can be taken for promotional reasons.

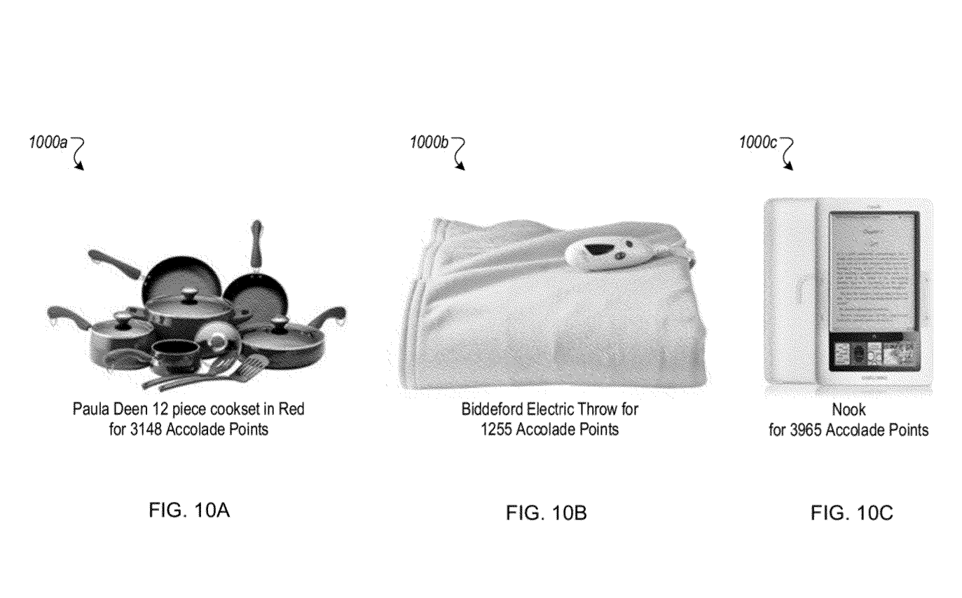

FIGS. 10A-10C show example displays 1000a-1000c of request rewards that associates can request. For example, the displays 1000a-1000c can include descriptions of the items and the number of points needed to acquire each item.

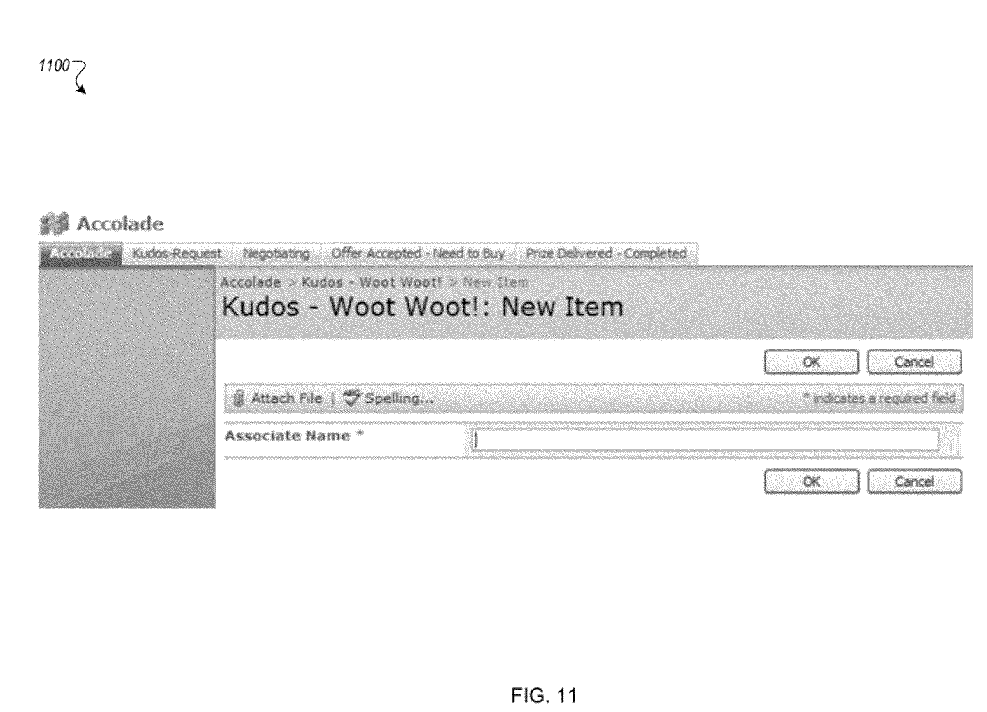

FIG. 11 is a screen shot of an example form 1100 on which the associate can register for discounted prizes. For example, prizes can be purchased in advance by the rewards program manager and placed on a SharePoint site that are available for redemption by associates for a specific point goal. Prizes can have a limited quantity, and associates can have an opportunity to obtain a prize based on a first-come, first-served basis. To sign up for a prize, associates can select a “New” button (e.g., on an interface used for discounted prizes) and fill out the form 1100.

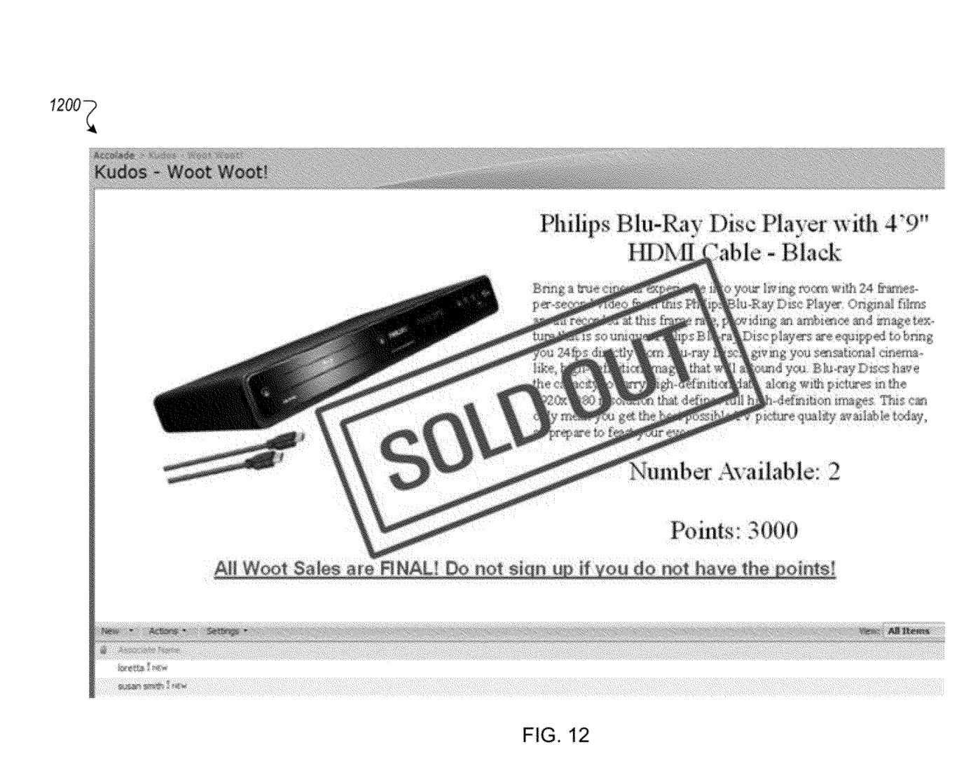

FIG. 12 is a screen shot of a sold-out display 1200. For example, the sold-out display 1200 can be displayed to the associate once the allotted number of prizes has been signed for.

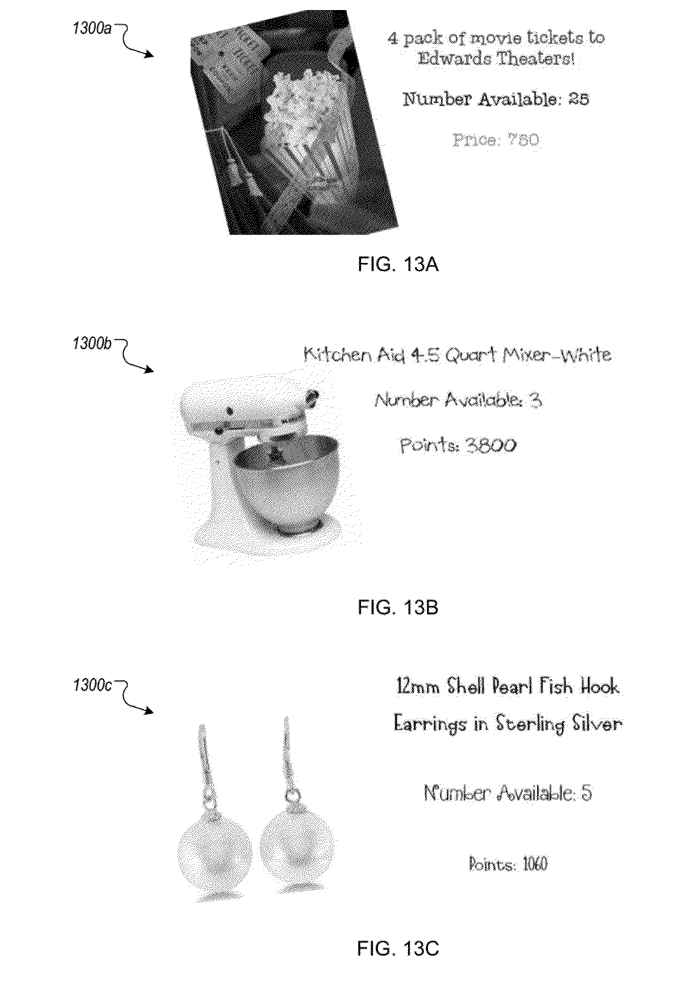

FIGS. 13A-13C show example discounted prizes 1300a-1300c.

In some implementations, the rewards program can include daily, weekly and monthly promotions. For example, the number and length of the promotions can be determined by incentive teams working with marketing departments to decide which product and/or service to promote each month in order to meet company goals.

For monthly promotions, each call center can have a new theme each month. For example, the monthly theme can be evident in the monthly focus of the call center, as well as the decorations and environment of the call center and monthly promotions (e.g., “Prize Specials”). For example, “Prize Specials” can include prizes that can appear in the rewards 102 on the rewards/points display 100 (e.g., “Reward Vault”), and the prizes can be available for a limited time and in limited quantities.

Examples prize specials can include: five sets of movie passes that are available for day only, ten restaurant gift cards that are available for one week only, three new-release movies available to the first associates that redeem them.

Prize specials can include the use of the following special terms. Tracking slips, for example, can be electronic forms that associates fill out on computer-systems with their name, employee number, supervisor, and the invoice numbers corresponding to the monthly featured product/service they sold. Keno slips, for example, can be same as a tracking slip, but meant for the Keno board. Accolade points, for example, can be amount of points given for a prize special, and the points can vary depending upon the monthly promotion. Conversion rate, for example, can be determined by a computer system by taking the number of products/services sold by an associate and dividing that number by the number sales invoices the associate has created during the allotted time frame. The number that this creates is their personal conversion rate.

When monthly drawings are used, associates can fill out tracking slips for the monthly featured product/service. Slips can be entered into a drawing, and after the month is complete, a manager in the incentive team can draw slips, such as by causing a random computer process to select a particular slip—where the randomness can be weighted according to the number of points or other indicators of value that each employee has entered into the process. Associates whose names are drawn can be given accolade points.

Top sellers in a month can be recognized. For example, the associate who sells the most of the featured product/service within the month can be rewarded with accolade points. In some implementations, top-seller recognition can be limited to one individual. In some implementations, there can be one winner in each call center, or winners can be chosen from the top three sellers, the top five sellers, the top ten sellers, and so on. Other ways of selecting top sellers can be used.

Top conversions in a month can also be recognized. For example, the associate with the highest conversion rate for the time period allotted can be rewarded with accolade points. This recognition can be limited to one individual, or there can be one winner in each call center. The rewards program can also choose to reward the top three, top five or top ten conversion rates, for example.

Team incentives can be used, and the top teams in a month can be recognized. For example, the first team(s) (e.g., one or more) to have every associate on their team (e.g., including or excluding team leads and supervisors) sell a specified or pre-determined number of products/services can receive an allotted number of accolade points (e.g., awarded to each member on the team).

Team incentive variations can be used. For example, every team that is able to accomplish having every team member (e.g., including or excluding team leads and supervisors) sell a specified or pre-determined number of products/services within a stated amount of time will get to split a “pool” of accolade points. In another example, the team that sells the most in the specified amount of time can be awarded accolade points (e.g., including or excluding team leads and supervisors).

When monthly drawings are used, for example, associates can fill out tracking slips for the monthly featured product/service. Slips can be entered into a weekly drawing, and winning associates can be awarded accolade points.

Some implementations of weekly incentives and drawings can use a Keno board. For example, each associate can be given Keno slips to fill out. When they have sold the required amount, they can take their Keno slip to the Keno board and place it anywhere on the board that they choose. On a specified day each week, keno numbers can be drawn (e.g., by the incentive team), and winning associates can be awarded accolade points.

Some implementations can use scratch tickets which can be tickets that are given to associates who sell the required amount of the featured product/service. The associates can be allowed to scratch off only specified number of (e.g., six) spaces on their ticket. If they match, 4, 5, or 6 icons on their ticket, they can win. The amount of accolade points they are given can depend upon how many matching icons they scratch off.

When daily incentives are used, for example, associates can participate in dress-up days, e.g., by wearing clothing or costumes that correspond to specific themes on specified days. Costume contests can be held, and the associate who wears the best costume in each call center can be awarded accolade points.

Associates can also participate in power hours. For example, the associate in each call center who is able to sell the most featured product/service within the hour can receive accolade points. The associates keep track on a tracking sheet, which may be a graphical user interface representation of various data structures for tracking employee progress, where they report the invoice numbers their sales were made on, and the sheets can be turned in.

Teams can also participate in a passing game. The teams can select an object (e.g., a reward prize) to pass, and a featured product/service on which the passing game is based. Once an object has been selected, the first person to sell the featured product/service sets the object on their desk. The next person to sell the featured product/service takes the object and sets it on their desk. Associates on the team continue to pass the object around as they make sales. The incentive team can come around at random, unannounced times and award accolade points to the associate with the object on their desk at those times.

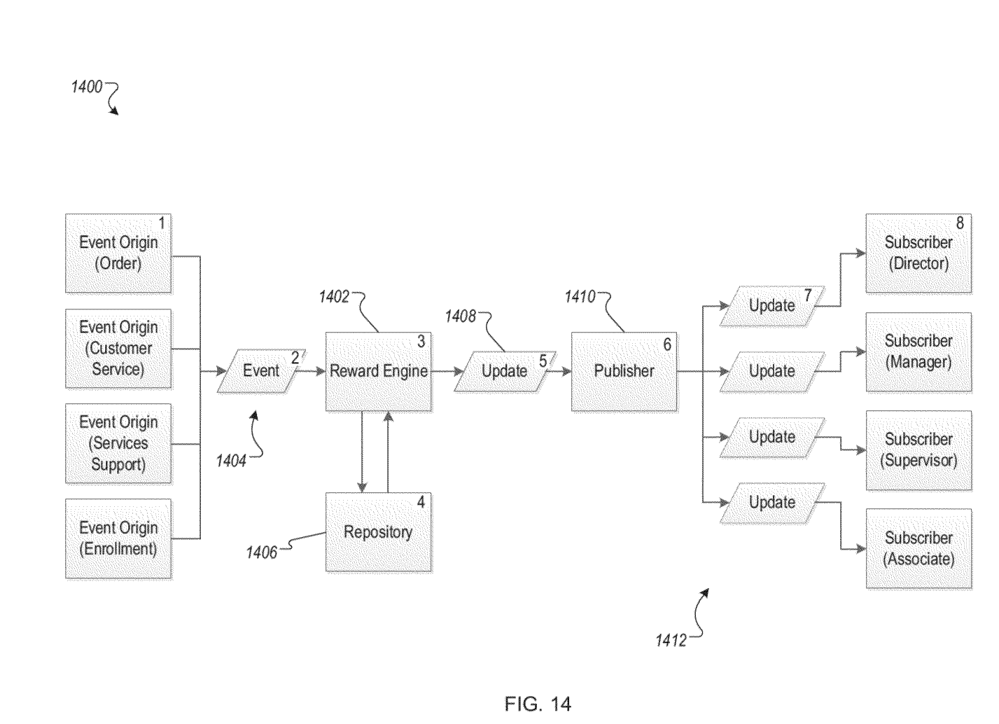

FIG. 14 is a block diagram of an example flow of events 1400 in the rewards program. For example, a reward engine 1402 can receive events 1404. Depending on the type of events 1404 received, the reward engine 1402 can update a points/transactions data store 1406. The reward engine 1402 can provide reward updates 1408 to a reward publisher 1410 for publication to various recipients 1412. The system shown here may, in various embodiments, be used to carry out the many activities and functions described more fully above.

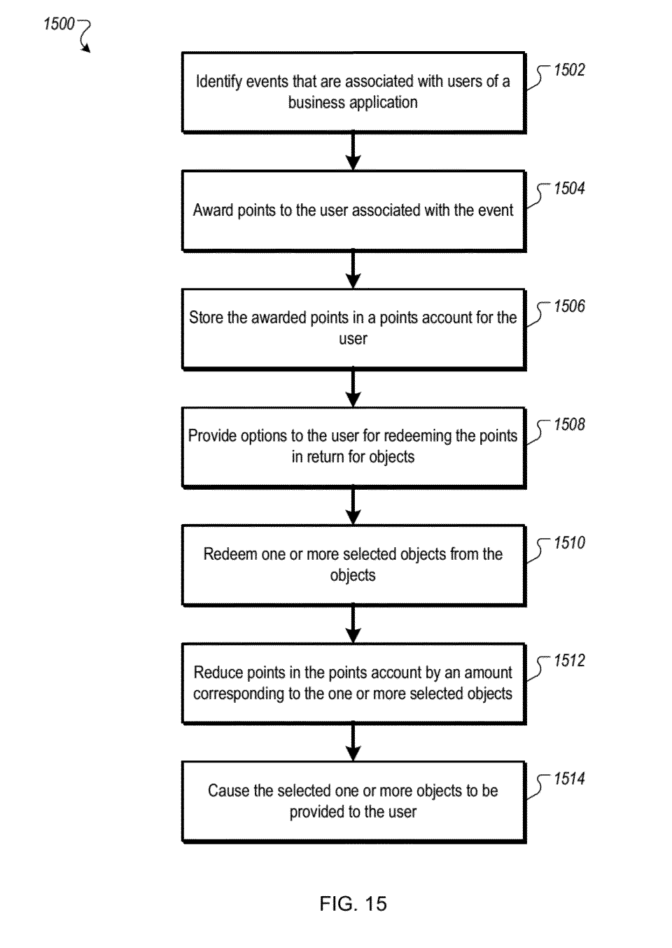

FIG. 15 is a flow diagram of an example process 1500 for the rewards program. In general, the process may be carried out by systems like those discussed above in the context of a call center for selling or supporting goods or services. The process itself involves tracking activities of users of a computer system to identify actions by the users that are correlated with increased business activity, awarding points to users for such actions, and then allowing the users to redeem the points for goods or services, among other things.

The process begins at box 1502, where events that are associated with users of a business software application are identified. For example, ongoing use of an application may be tracked in real-time. Certain events that are generated in the software for such use may be identified among all the many events, as those events may indicate particular actions that are relevant to a rewards system. For example, indications that orders have been completed or help tickets have been disposed of can be identified. Data about such events may also be obtained and stored, such as an identifier of the employee who made the sale or closed the ticket. Other activities may include the number of calls handled, the number of upsells of a particular type that are made, and the like.

At box 1504, points associated with the event are awarded to the user. For example, if an upsell event is identified, a dollar value of the upsell may also be identified, and points may be awarded to an account of the particular user based on such information. At box 1506, the awarded points are stored in an account for the user, and may be added to a pre-existing point total. Multiple different totals may be maintained for different types of points also. At box 1508, options are provided for the user to redeem the points. For example, a user may simply shop for items that have associated point costs to them. The costs may also be blended with cash costs, such that a $500 item could be obtained for $200 and 1000 points. Items may also be made available as part of an inter-employee auction, where employees are allowed to bid with their points when they are not otherwise required to do their jobs, such as between telephone calls when business is slow.

The user redeems one or more objects by selecting them at box 1510, and the system reduces points in the user's points account by an amount that corresponds to the one or more selected objects at box 1512. For example, where the $500 item is indicated as being obtainable for $200 and 1000 points and a user selects to acquire the item, then the system may take 1000 points out of the user's account.

Finally, at box 1514, the system causes the one or more objects to be provided to the user. For example, the items may be delivered to the user's desk, or a certificate or coupon for claiming the items may be so delivered. The delivery may be accompanied by a certain level of pomp so as to pique the interest of other users in the area, and to induce them to acquire points and corresponding objects, or items.

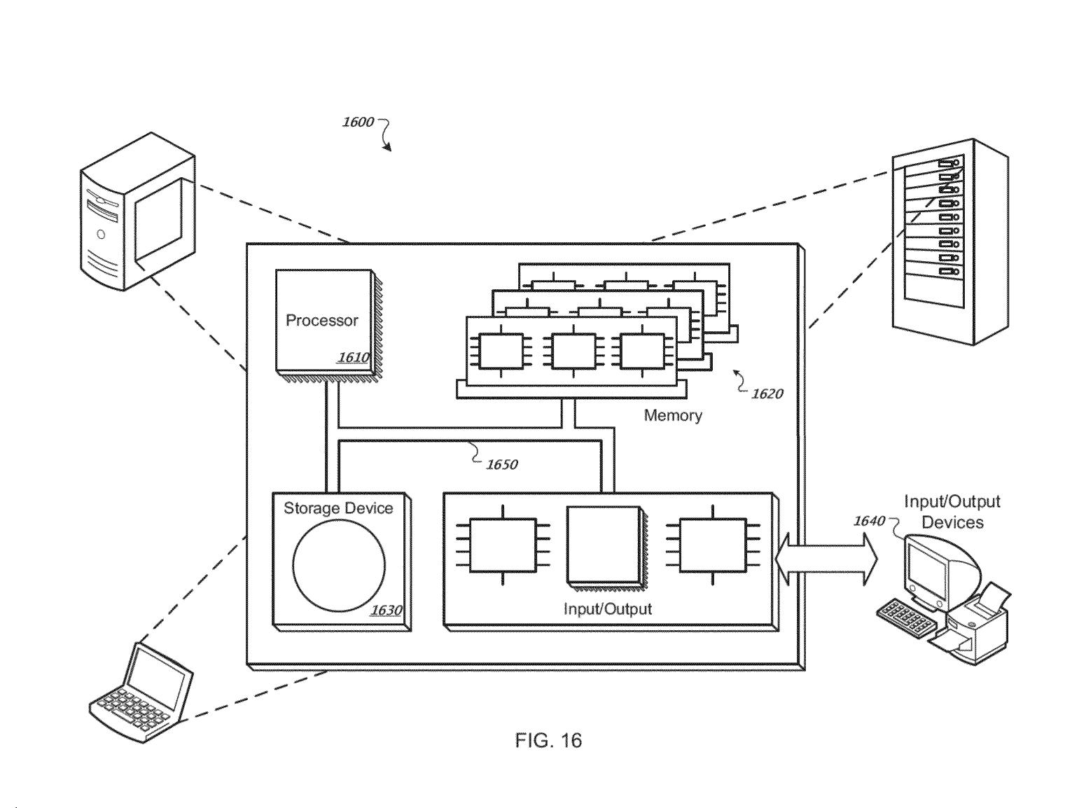

FIG. 16 is a schematic diagram of a generic computer system 1600. The system 1600 can be used for the operations described in association with any of the computer-implement methods described previously, according to one implementation. The system 1600 includes a processor 1610, a memory 1620, a storage device 1630, and an input/output device 1640. Each of the components 1610, 1620, 1630, and 1640 are interconnected using a system bus 1650. The processor 1610 is capable of processing instructions for execution within the system 1600. In one implementation, the processor 1610 is a single-threaded processor. In another implementation, the processor 1610 is a multi-threaded processor. The processor 1610 is capable of processing instructions stored in the memory 1620 or on the storage device 1630 to display graphical information for a user interface on the input/output device 1640.

The memory 1620 stores information within the system 1600. In one implementation, the memory 1620 is a computer-readable medium. In one implementation, the memory 1620 is a volatile memory unit. In another implementation, the memory 1620 is a non-volatile memory unit.

The storage device 1630 is capable of providing mass storage for the system 1600. In one implementation, the storage device 1630 is a computer-readable medium. In various different implementations, the storage device 1630 may be a floppy disk device, a hard disk device, an optical disk device, or a tape device.

The input/output device 1640 provides input/output operations for the system 1600. In one implementation, the input/output device 1640 includes a keyboard and/or pointing device. In another implementation, the input/output device 1640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for executing a points-based rewards program, the method comprising:
identifying, with a computer system, events that are associated with users of a business application;
awarding, in response to the occurrence of an event identified by the computer system, points to the user associated with the event, where the points awarded are based on a business importance of the event, the business importance being determined by the computer system;
storing the awarded points in a points account for the user;
providing options to the user for redeeming the points in return for objects;
redeeming, in response to a selected redemption option, one or more selected objects from the objects, and reducing points in the points account by an amount corresponding to the one or more selected objects; and
causing the selected one or more objects to be provided to the user.

2. The method of claim 1, further comprising:
providing a negotiation tool for enabling the user to negotiate a number of points to be used in redemption for an object, wherein the negotiation tool:
enables offers, by the user, for obtaining the object for a reduced number of points; and
enables counter-offers, by an administrator of the rewards program, in response to offers from the user.

3. The method of claim 1, further comprising providing an auction for one or more users to bid on selected objects using points from their points accounts.

4. The method of claim 1, further comprising using metrics to adjust the points awarded in response to the occurrence of the event.

5. The method of claim 4, wherein adjusting the points comprises rewarding the user with additional points that are awarded based on metrics.

6. The method of claim 4, wherein adjusting the points comprises retracting points from the user based on an occurrence of an event that has a negative business impact.

7. The method of claim 1, wherein the event comprises an event selected from a group consisting of sales calls, conversions, orders placed, enrollments completed, customer service calls, service support calls, business development calls, and outbound calls.

8. One or more tangible machine-readable media having recorded thereon instructions that, when executed, cause the performance of operations comprising:
identifying, with a computer system, events that are associated with users of a business application;
awarding, in response to the occurrence of an event identified by the computer system, points to the user associated with the event, where the points awarded are based on a business importance of the event, the business importance being determined by the computer system;
storing the awarded points in a points account for the user;
providing options to the user for redeeming the points in return for objects;
redeeming, in response to a selected redemption option, one or more selected objects from the objects, and reducing points in the points account by an amount corresponding to the one or more selected objects; and
causing the selected one or more objects to be provided to the user.

9. The tangible recordable media of claim 8, wherein the operations further comprise:
providing a negotiation tool for enabling the user to negotiate a number of points to be used in redemption for an object, wherein the negotiation tool:
enables offers, by the user, for obtaining the object for a reduced number of points; and
enables counter-offers, by an administrator of the rewards program, in response to offers from the user.

10. The tangible recordable media of claim 8, wherein the operations further comprise providing an auction for one or more users to bid on selected objects using points from their points accounts.

11. The tangible recordable media of claim 8, wherein the operations further comprise using metrics to adjust the points awarded in response to the occurrence of the event.

12. The tangible recordable media of claim 11, wherein adjusting the points comprises rewarding the user with additional points that are awarded based on metrics.

13. The tangible recordable media of claim 11, wherein adjusting the points comprises retracting points from the user based on an occurrence of an event that has a negative business impact.

14. The tangible recordable media of claim 8, wherein the event is an event selected from a group consisting of sales calls, conversions, orders placed, enrollments completed, customer service calls, service support calls, business development calls, and outbound calls.
